(19) United States
(12) Patent Application Publication
(10) Pub. No.: US 2025/0138768 A1
(43) Pub. Date: May 1, 2025

(54) CONTROL DEVICE, CONTROL METHOD, AND STORAGE MEDIUM

(71) Applicant: Panasonic Automotive Systems Co., Ltd., Kanagawa (JP)

(72) Inventors: Kazuki KUZU, Kanagawa (JP); Junya YUSA, Kanagawa (JP)

(73) Assignee: Panasonic Automotive Systems Co., Ltd., Kanagawa (JP)

(21) Appl. No.: 19/011,134

(22) Filed: Jan. 6, 2025

Related U.S. Application Data
(63) Continuation of application No. PCT/JP2023/025121, filed on Jul. 6, 2023.

(30) Foreign Application Priority Data
Jul. 20, 2022 (JP) 2022-115428

(51) Int. Cl. G06F 3/14; G06V 20/59

(52) U.S. Cl. CPC G06F 3/1423; G06V 20/59; G06V 2201/02

(57) ABSTRACT

A control device includes: an obtainer (a controller) that obtains area information that is related to a display area of a first display screen in which an image is displayed; and a processor (a defective range identification processor) that identifies a defective area that is included in the display area, based on the obtained area information, and outputs the identified defective area.

### CROSS REFERENCE TO RELATED APPLICATIONS

This is a continuation application of PCT International Application No. PCT/JP2023/025121 filed on Jul. 6, 2023, designating the United States of America, which is based on and claims priority of Japanese Patent Application No. 2022-115428 filed on Jul. 20, 2022.

### FIELD

The present disclosure relates to a control device, a control method, and a storage medium.

### BACKGROUND

Patent Literature (PTL) 1 discloses a display device for vehicles that displays various information related to the vehicles. The display device includes a detector that detects the occurrence of a defect for each of a plurality of display units, and a controller that displays images on the non-defective display units in order of importance based on a detection signal that indicates the occurrence of the defect detected by the detector.

### CITATION LIST

### Patent Literature

PTL 1: Japanese Unexamined Patent Application Publication No. 2017-121841

### SUMMARY

However, the display device according to PTL 1 can be improved upon.

In view of this, an object of the present disclosure is to provide a control device and the like capable of improving upon the above related art.

A control device according to one aspect of the present disclosure includes: an obtainer that obtains area information that is related to a display area of a first display screen in which an image is displayed; and a processor that identifies a defective area that is included in the display area, based on the area information obtained, and outputs the defective area identified.

Moreover, a control method according to one aspect of the present disclosure includes: obtaining area information that is related to a display area of a first display screen in which an image is displayed; and identifying a defective area that is included in the display area, based on the area information obtained, and outputting the defective area identified.

Moreover, a storage medium according to one aspect of the present disclosure is a non-transitory computer-readable recording medium having recorded thereon a program for causing a computer to execute the control method.

A control device and the like according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 schematically illustrates a display system according to an embodiment.

FIG. 2 is a block diagram illustrating the display system according to the embodiment.

FIG. 3 schematically illustrates normal areas, defective areas, defect detection images, and the like on a first display screen in the display system according to the embodiment.

FIG. 4 is a flowchart illustrating an operation example of the display system according to the embodiment.

FIG. 5 schematically illustrates a case in which an image of a given tile in a defect detection image displayed on the first display screen has been incorrectly selected.

FIG. 6 is a block diagram illustrating a display system according to Variation 1 of the embodiment.

FIG. 7 schematically illustrates a state in which a normal area is input to a second display screen on which a defect detection image is displayed in the display system according to Variation 1 of the embodiment.

FIG. 8 is a block diagram illustrating a display system according to Variation 2 of the embodiment.

FIG. 9 schematically illustrates a state in which a defect detection image is displayed on a first display screen in the display system according to Variation 2 of the embodiment.

FIG. 10 is a flowchart illustrating an operation example of the display system according to Variation 2 of the embodiment.

### DESCRIPTION OF EMBODIMENT

It should be noted that the embodiment described below shows a general or specific example. The numerical values, shapes, materials, structural elements, arrangement positions and connection forms of the structural elements, steps, the order of steps, etc. shown in the following embodiment are examples, and are not intended to limit the present disclosure. Moreover, among the structural elements in the embodiment below, the structural elements not described in independent claims will be described as arbitrary structural elements.

Note that the respective figures are schematic diagrams and are not necessarily precise illustrations. Additionally, the structural elements that are essentially the same share like reference numerals in the respective figures.

Hereinafter, an embodiment will be specifically described with reference to the drawings.

### Embodiment

### <Configuration and Function>

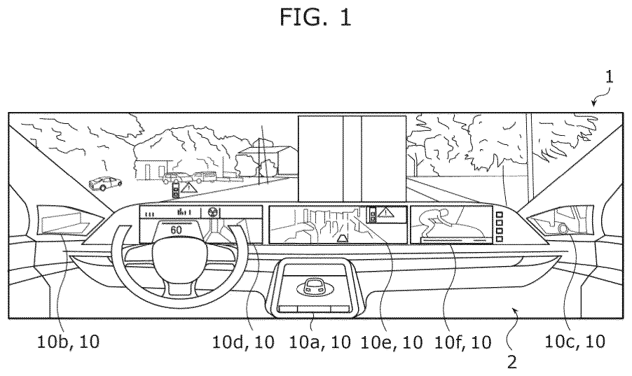

First, display system 1 according to the present embodiment will be described with reference to FIG. 1 to FIG. 3.

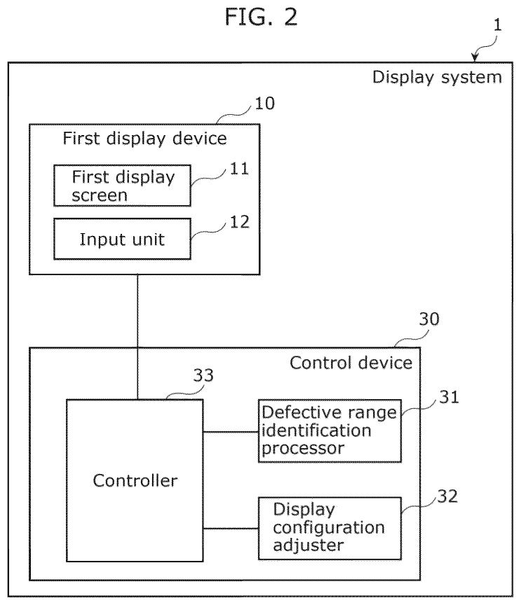

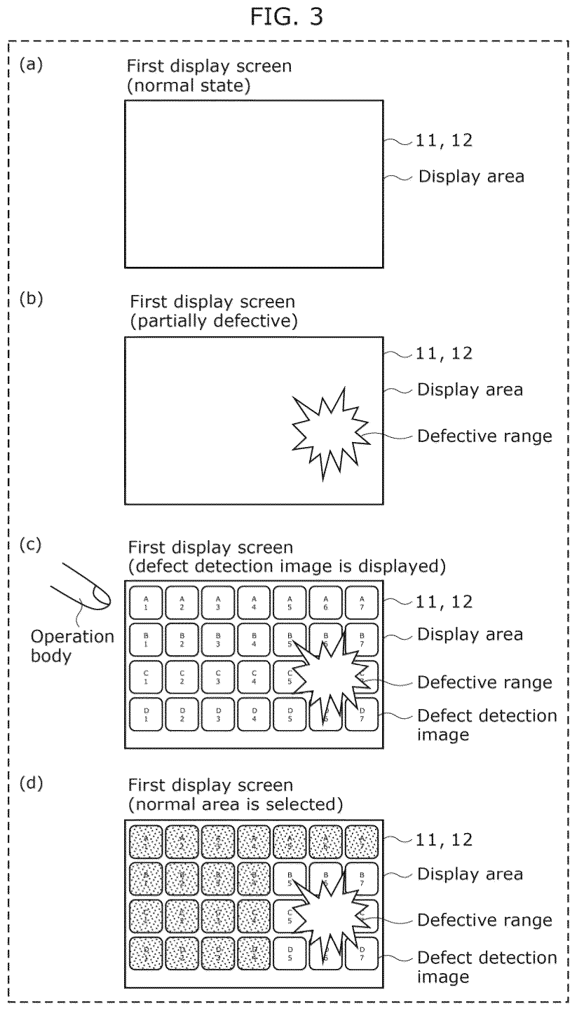

FIG. 1 schematically illustrates display system 1 according to an embodiment. FIG. 2 is a block diagram illustrating display system 1 according to the embodiment. FIG. 3 schematically illustrates normal areas, defective areas, defect detection images, and the like on first display screen 11.

As illustrated in FIG. 1 and FIG. 2, display system 1 is a system for displaying a plurality of images on first display screens 11 of one or more first display devices 10. Specifically, display system 1 is capable of setting the display positions of a plurality of images on first display screens 11 of one or more first display devices 10 automatically or manually by the user.

When first display screen 11 is partially defective in display system 1, display system 1 displays an image in the area other than the defective portion. For example, even when first display screen 11 of given first display device 10 of one or more first display devices 10 is partially defective, display system 1 is capable of displaying a plurality of images by causing one or more first display devices 10 excluding the defective portion to work in conjunction with one another.

Display system 1 is used for vehicle 2 or the like in which one or more display devices 10 are mounted. Therefore, in the present embodiment, the plurality of images are images displayed based on an application. For example, the images include information such as vehicle instruments, the operating statuses of in-vehicle devices, navigation information, captured images, and surrounding vehicle information. Examples of the vehicle instruments include a speed meter, a direction indicator light, a warning light, an odometer, a shift position indicator, a fuel gauge, and a water temperature gauge. Examples of the in-vehicle devices include a sound device, an in-vehicle lighting device, and a seating device. The navigation information is used by the driver, when traveling in vehicle 2, to find the current location and receive routing assistance to reach a destination, for example. The captured image is an image of the surrounding or inside of vehicle 2, captured by an image capturing device included in vehicle 2. The surrounding vehicle information indicates the presence or absence of a surrounding vehicle near vehicle 2, the number of surrounding vehicles, the speed of the surrounding vehicle, and a distance between vehicle 2 and the surrounding vehicle, for example

Specifically, as illustrated in FIG. 2, display system 1 includes one or more first display devices 10 and control device 30.

### [First Display Device 10]

First display device 10 is, for example, a personal computer (PC) that includes a liquid crystal display or the like, a mobile terminal, or indicators such as an automotive navigation system, an electron mirror system, and a multi-information display that are included in vehicle 2.

FIG. 1 illustrates, as examples of first display devices 10, automotive navigation system 10a positioned in the midsection in the vehicle width direction, an electronic mirror system that functions as left-side mirror 10b and right-side mirror 10c, and a plurality of multi-information displays 10d, 10e, and 10f. These first display devices 10 are arranged side by side in order for the user of vehicle 2 to see first display devices 10 all at once.

When first display devices 10 are arranged side by side in vehicle 2, first display devices 10 are capable of displaying a single image or each of first display devices 10 is capable of displaying an individual image by being controlled by display system 1 in conjunction with each other. In the present embodiment, a description will be given focusing on one first display device 10, unless otherwise noted.

First display device 10 includes first display screen 11 and input unit 12.

First display screen 11 is a display that includes a display area, and is capable of displaying an image in the display area. The display area is the entire area of first display screen 11, and includes a defective area to be described below. First display screen 11 is a display panel, such as a liquid crystal panel or an organic electroluminescent (EL) panel. First display screen 11, for example, displays a graphical user interface (GUI) for operating automotive navigation maps, menu images for various in-vehicle devices, or search images.

Input unit 12 is a touch sensor that is capable of receiving a user operation, and detects the contact position of an operation body on the operation surface. Input unit 12 is positioned so as to overlap with the display area of first display screen 11. Input unit 12 detects, for example, an operation in which an operation body is brought into contact with the operation surface, or an operation in which the operation body is moved along the operation surface while the operation body is in contact with the operation surface. Input unit 12 outputs a signal to control device 30 in response to the user operation.

As illustrated in (a) and (b) of FIG. 3, first display screen 11 in a normal state may become partially defective. At this time, input unit 12 may be non-defective. In this case, input unit 12 receives an input of area information for identifying the defective area that includes the defective range, as illustrated in (c) and (d) of FIG. 3. The area information is information that is related to the display area of first display screen 11 in which an image is displayed. The area information includes a normal area in which an image can be displayed normally or a defective area in which an image cannot be displayed normally. At the time of input, the sizes and position coordinates of the normal area and the defective area in the display area are associated with each other. The defective area is an area in the display area of first display screen 11 in which an image cannot be displayed normally. The normal area is the display area of first display screen 11 excluding the defective area, and is the area in which an image can be displayed normally.

For example, at the time of input of area information to input unit 12, first display screen 11 displays a defect detection image that is a GUI for inputting the area information. The defect detection image is, as illustrated in (c) of FIG. 3, a plurality of images of tiles arranged in a matrix on first display screen 11. When the user selects a normal range or a defective range on the defect detection image on first display screen 11 with use of the operation body, controller 30 changes the colors of the images of the selected tiles, as indicated by the hatching of dots in (d) of FIG. 3. This allows the user to recognize the selected range. In such a manner, the normal area or the defective area is input to input unit 12 by the user selecting the images of the tiles displayed on first display screen 11 according to the normal range or the defective range on the defect detection image on first display screen 11. Therefore, input unit 12 is capable of receiving the area information that includes the normal area or the defective area by a user operation. Input unit 12 outputs the received area information to control device 30.

The size of the image of each tile included in the defect detection image can be set arbitrarily. For example, a tiled image with two vertical tiles and two horizontal tiles may be displayed as a defect detection image, or a tiled image with four vertical tiles and seven horizontal tiles may be displayed as a defect detection image, as illustrated in (c) of FIG. 3. For example, the form of the image of each tile may be circular or polygonal, or the tiled image may be diagonally shaded, wavy shaded, or dotted. The form of the image of each tile is not limited to such examples, and may be in any other known form.

Although (d) of FIG. 3 illustrates an example of the case in which a normal area corresponding to a normal range is selected as a tiled image including A1 to A7, B1 to B4, C1 to C4, and D1 to D4, the present disclosure is not limited to such an example. For example, when a defective area corresponding to a defective range is to be selected, the user would select a tiled image including B5 to B7, C5 to C7, and D5 to D7.

In both when the user selects a normal area and when the user selects a defective area, input unit 12 is also capable of receiving the defective area by the user bringing the operation body into contact with first display screen 11, or by the user moving the operation body to surround the defective area while keeping the operation body in contact with first display screen 11, without using the tiled image as the defect detection image.

### [Control Device 30]

As illustrated in FIG. 2, control device 30 causes one or more first display devices 10 to display a plurality of images on first display screens 11 of first display devices 10. Control device 30 also causes first display device 10 to display, on first display screen 11, a defect detection image that is a GUI for inputting area information.

Specifically, when the user starts an application for determining a defective range, control device 30 causes first display device 10 to display a defect detection image on the application. As described above, since a normal area or a defective area is input by the user to input unit 12, control device 30 is capable of identifying the normal area excluding the defective area when first display screen 11 is partially defective. Furthermore, control device 30 may be capable of performing control such that an image is displayed in the identified normal area.

Specifically, control device 30 includes controller 33, defective range identification processor 31, and display configuration adjuster 32.

Controller 33 controls defective range identification processor 31. Specifically, controller 33 obtains, from first display device 10, the area information that is related to the display area of first display screen 11 in which an image is displayed. Controller 33 outputs the obtained area information to defective range identification processor 31, and causes defective range identification processor 31 to identify the defective area based on the area information. Controller 33 is an example of an obtainer. Controller 33 may also be an example of a processor. An obtainer, such as an input interface, may be separately included in control device 30.

By being controlled by controller 33, defective range identification processor 31 identifies the defective area included in the display area based on the area information obtained from controller 33. Specifically, when the user inputs a normal area to input unit 12, the area information includes the normal area. Hence, defective range identification processor 31 identifies, as the defective area, the display area of first display screen 11 excluding the normal area. When the user inputs a defective area to input unit 12, the defective area is included in the area information. Hence, defective range identification processor 31 is capable of identifying the defective area in the display area of first display screen 11. Defective range identification processor 31 outputs the identified defective area to controller 33. Defective range identification processor 31 is an example of a processor.

Controller 33 also controls display configuration adjuster 32. Specifically, display configuration adjuster 32 obtains the defective area identified by defective range identification processor 31 via controller 33. Display configuration adjuster 32 then adjusts the display range on first display screen 11 based on the defective area, by being controlled by controller 33. In other words, display configuration adjuster 32 may reconstruct the display area on first display screen 11 so that an image is displayed only in the normal area excluding the identified defective area.

Display configuration adjuster 32 performs rendering processing in which the lightness (brightness), contrast, gamma value, color tone, etc. of the image displayed in the reconstructed normal area are adjusted, based on the reconstructed normal area and a rendering command for performing rendering processing, by being controlled by controller 33. Display configuration adjuster 32 outputs the image on which the rendering processing has been performed to controller 33. Controller 33 outputs, to first display device 10, the image on which the rendering processing has been performed, so that the image is displayed in the reconstructed normal area.

This allows control device 30 to identify the defective area included in the display area, even when first display screen 11 is partially defective. Therefore, display system 1 is capable of displaying an image in the normal area excluding the identified defective area.

### <Processing Operation>

The processing operation of control device 30, a control method, and a program according to the present embodiment will be described.

### Operation Example

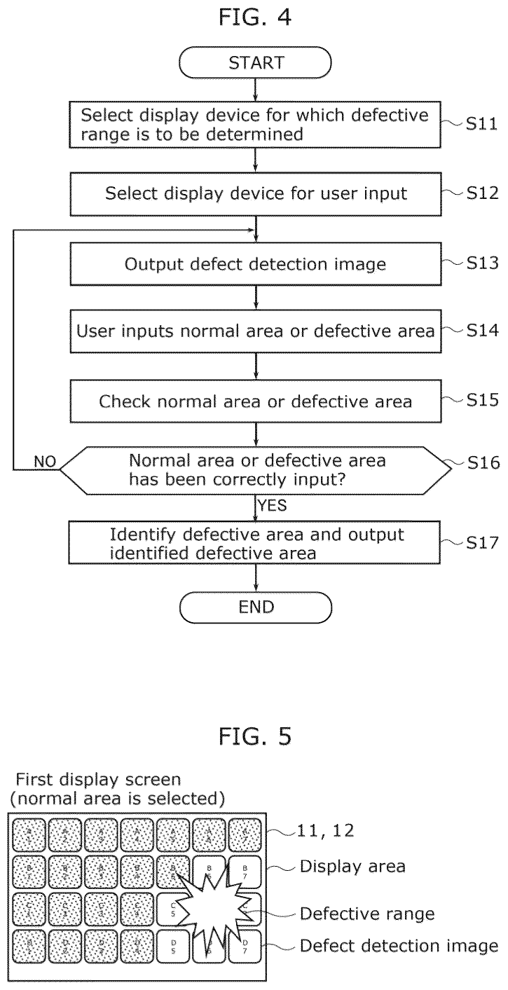

First, the case where one first display screen 11 is partially defective will be described with reference to FIG. 4 and FIG. 5.

FIG. 4 is a flowchart illustrating an operation example of display system 1 according to the embodiment. FIG. 5 schematically illustrates a case in which an image of a given tile in a defect detection image displayed on first display screen 11 has been incorrectly selected.

First, a display device for which a defective range is to be determined is selected (S11). Specifically, the user starts an application for determining a defective range, and selects a display device for which the defective range is to be determined from the GUI displayed on the application. This operation example assumes a case where first display device 10 is partially defective. Therefore, the user performs an operation on first display screen 11 of first display device 10 to select first display device 10 as a display device for which the defective range is to be determined.

Next, the user selects a display device for input (S12). In this operation example, first display device 10 is selected as the display device for user input.

Next, control device 30 outputs a defect detection image on first display screen 11 as illustrated in (c) of FIG. 3 (S13). This causes the defect detection image to be displayed on first display screen 11.

Next, as illustrated in (c) of FIG. 3, the user selects a normal area corresponding to a normal range or a defective area corresponding to a defective range (area information) in the defect detection image displayed on first display screen 11 of first display device 10, and makes an input to input unit 12 (S14). Control device 30 changes the colors of the images of the tiles corresponding to the area information input to input unit 12, and displays the changed colors on first display screen 11.

Next, the user checks the normal area or the defective area displayed on first display screen 11 (S15). For example, as illustrated in FIG. 5, the user may incorrectly select, as the normal area, tile image B5 corresponding to the defective area. Even in this case, by tapping incorrectly selected tile image B5 again, tile image B5 can be released from the normal area selection, as illustrated in (d) of FIG. 3.

Next, control device 30 causes the user to confirm whether the normal area or the defective area has been correctly input (S16). In this case, control device 30 may display, on first display screen 11, a selection image for confirming whether the normal area or the defective area has been correctly input. The selection image is, for example, an image of YES, NO, and the like.

When the user has not correctly input the normal area or the defective area (NO in S16), for example, when the user selects an image of NO indicating that an input has not been correctly made on first display screen 11, the processing returns to step S13 and a defect detection image is rendered. In this case, for example, control device 30 renders a defect detection image on first display screen 11. This allows the user to input the normal area or the defective area (area information) again to input unit 12.

On the other hand, when the user has correctly input the normal area or the defective area (YES in S16), for example, when the user selects a selection image of YES indicating that an input has been correctly made on first display screen 11, control device 30 obtains the normal area or the defective area (area information) input to input unit 12 from first display device 10. Defective range identification processor 31 of control device 30 identifies the defective area included in the display area based on the obtained area information, by being controlled by controller 33. As illustrated in (d) of FIG. 3, when the user inputs a normal area corresponding to the normal range to input unit 12, the area information includes the normal area. Therefore, it is possible to identify, as the defective area, the display area of first display screen 11 excluding the normal area. Defective range identification processor 31 outputs the identified defective area to controller 33 (S17), and then ends the processing operation in the flowchart in FIG. 4.

In such a manner, even when first display screen 11 includes a defective area, control device 30 is capable of identifying the defective area included in the display area. Therefore, display system 1 is capable of displaying an image in the normal area excluding the identified defective area.

For example, controller 33 causes display configuration adjuster 32 to generate an image on which the rendering processing has been performed. Control device 30 outputs the image on which the rendering processing has been performed to first display device 10 so that the image is displayed in the normal area. By doing so, control device 30 is capable of displaying the image only in the normal area that is the display area excluding the defective area.

### Operational Effects

Next, operational effects of control device 30, the control method, and the program according to the present embodiment will be described.

For example, in the display device according to PTL 1, in order to detect a partial defective range on the display unit, a component for detecting the defective range is required. This increases the number of components, leading to an increase in manufacturing cost of the display device.

In view of the above, as described above, control device 30 according to the present embodiment includes: an obtainer (controller 33) that obtains area information that is related to the display area of first display screen 11 on which an image is displayed; and a processor (defective range identification processor 31) that identifies a defective area included in the display area based on the obtained area information, and outputs the identified defective area.

With this, since the display area of first display screen 11 is included in the area information, when first display screen 11 is partially defective, the defective area can be identified based on the area information. This eliminates the need for control device 30 to use a component or a device for identifying the defective area of first display screen 11.

Therefore, control device 30 is capable of reducing an increase in manufacturing cost due to an increase in the number of components used to identify the defective area.

In particular, once control device 30 identifies the defective area, it is possible to reconstruct the normal area with use of the identified defective area so that an image is displayed only in the normal area. In this case, since the image can be displayed only in the reconstructed normal area, it is not necessary to treat the partial defect in one first display screen 11 as a defect of one first display screen 11. As a result, it is possible to prevent the display area from being significantly reduced, allowing the normal area other than the defective area to be effectively used. For example, when control device 30 according to the present embodiment is used in vehicle 2, even when first display screen 11 is partially defective, important information can still be presented to the user, thus ensuring the safety of the user.

Moreover, the control method according to the present embodiment includes obtaining area information that is related to the display area of first display screen 11 in which an image is displayed, identifying a defective area included in the display area based on the obtained area information, and outputting the identified defective area.

The control method also has the same operational effects as described above.

Moreover, the program according to the present embodiment is a program for causing a computer to execute the control method.

The program also has the same operational effects as described above.

In control device 30 according to the present embodiment, a normal area in which an image can be displayed normally or a defective area in which an image cannot be displayed normally is input to first display device 10 that includes first display screen 11. The obtainer then obtains area information that includes the normal area or the defective area from first display device 10.

This allows control device 30 to obtain the area information that includes the normal area or the defective area. Therefore, when obtaining the area information that includes the normal area, control device 30 is capable of identifying, as a defective area, the display area excluding the normal area. Moreover, when obtaining the area information that includes the defective area, control device 30 is capable of identifying the defective area in the display area.

Moreover, in control device 30 according to the present embodiment, the processor outputs, to first display screen 11, a defect detection image for inputting at least one of the normal area or the defective area. The obtainer then obtains the area information that includes the normal area or the defective area input.

With this, a defect detection image is displayed on first display screen 11. Therefore, the user is able to directly input the normal area corresponding to the normal range or the defective area corresponding to the defective range in the detect detection image on first display screen 11. This allows control device 30 to obtain the area information that includes the normal area or the defective area. As a result, it is possible to identify the defective area on first display screen 11.

### Variation 1 of Embodiment

Variation 1 differs from the embodiment in that two display devices are used and that first display device 110 does not include an input unit. Unless otherwise specified, the other structural elements in Variation 1 are similar to those in the embodiment. The similar structural elements are marked with the same reference numerals, and will not be described in detail.

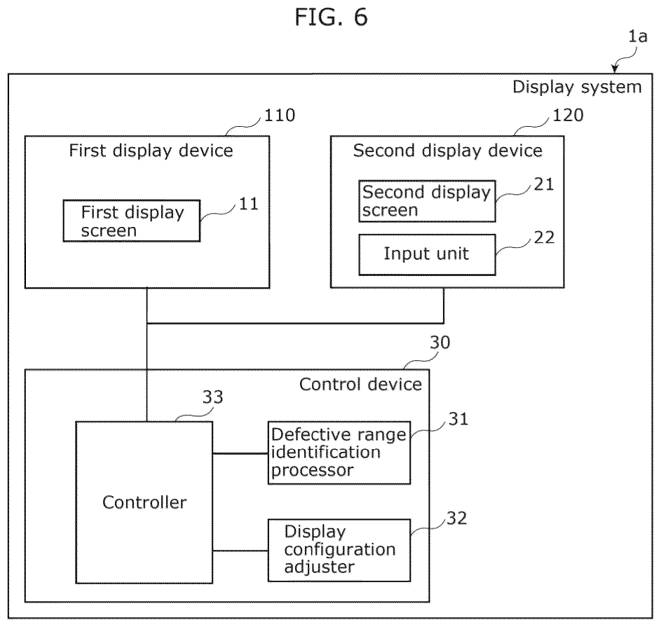

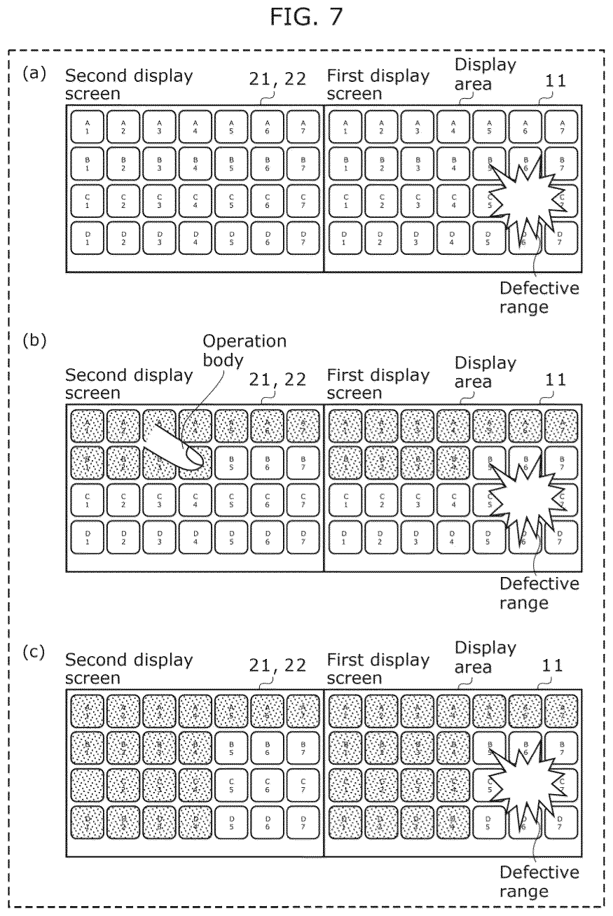

First, display system 1a according to Variation 1 will be described with reference to FIG. 6 and FIG. 7.

FIG. 6 is a block diagram illustrating display system 1a according to Variation 1 of the embodiment. FIG. 7 schematically illustrates a state in which a normal area is input to second display screen 21 on which a defect detection image is displayed in display system 1a according to Variation 1 of the embodiment.

First display device 110 according to Variation 1 includes first display screen 11, and does not include an input unit such as a touch sensor.

In addition to first display device 110 and control device 30, display system 1a according to Variation 1 includes second display device 120.

Second display device 120 is a display unit such as an automotive navigation system, electronic mirror system or multi-information display mounted on vehicle 2 illustrated in FIG. 1. Alternatively, second display device 120 may be a portable terminal such as a smartphone, or a PC that includes a display screen and an input unit such as a touch sensor.

Second display device 120 includes second display screen 21 and input unit 22.

Second display screen 21 is a display that includes a display area, and is capable of displaying an image in the display area. The display area is the entire area of second display screen 21, and includes a defective area to be described below. Second display screen 21 is, for example, a display panel, such as a liquid crystal panel or an organic electroluminescent (EL) panel. Second display screen 21, for example, displays a GUI for operating automotive navigation maps, menu images for various in-vehicle devices, or search images. Second display screen 21 may have the same configuration as first display screen 11.

Input unit 22 is a touch center that is capable of receiving a user operation, and detects the contact position of the operation body on the operation surface. Input unit 22 is positioned so as to overlap with the display area of second display screen 21. Input unit 22 detects, for example, an operation in which an operation body is brought into contact with the operation surface, and an operation in which the operation body is moved along the operation surface while the operation body is in contact with the operation surface. Input unit 22 outputs a signal corresponding to a user operation to control device 30.

As illustrated in (a) of FIG. 7, first display screen 11 may be partially defective. In this case, when first display device 110 does not include an input unit such as a touch sensor, second display device 120 that includes input unit 22 can be used to allow the user to input area information for identifying the defective area to input unit 22, as illustrated in (b) and (c) of FIG. 7. For example, when the user inputs area information to input unit 22, second display screen 21 displays a defect detection image that is a GUI for inputting the area information. When the user selects the normal range or the defective range on the defect detection image on first display screen 11 with use of the operation body, controller 30 changes the colors of the images of the selected tiles, as indicated by the hatching of dots in (b) and (c) of FIG. 7. At this time, control device 30 also changes the colors of the images of the tiles on first display screen 11 in conjunction with changing the colors of the images of the tiles on second display screen 21. This allows the user to recognize the selected range with use of first display device 110 and second display device 120. In such a manner, the normal area or the defective area is input to input unit 22 by the user selecting the images of the tiles according to the normal range or the defective range on the defect detection image on first display screen 11. Therefore, input unit 22 is capable of receiving area information that includes a normal area or a defective area by a user operation. Input unit 22 outputs the received area information to control device 30.

Next, an operation example of control device 30, the control method, and the program according to Variation 1 will be described with reference to FIG. 4 and the like.

This operation example assumes a case where one first display screen 11 is partially defective. Since this operation example is similar to the operation example in FIG. 4, the same steps are used for the same operations as those in FIG. 4 according to the embodiment, and the descriptions thereof are omitted as appropriate.

First, a display device for which a defective range is to be determined is selected (S11). This operation example assumes a case where first display device 110 is partially defective. Therefore, the user performs an operation on first display screen 11 of first display device 110 to select first display device 110 as a display device for which a defective range is to be determined.

Next, the user selects a display device for input (S12). In this operation example, second display device 120 is selected as the display device for user input.

Next, control device 30 outputs a defect detection image to first display screen 11 and second display screen 21 as illustrated in (a) of FIG. 7 (S13). Control device 30 may output the defect detection image only to second display screen 21.

Next, the user selects the normal area corresponding to the normal range or the defective area corresponding to the defective range (area information) in the defect detection image displayed on second display screen 21 of second display device 120, so that the user makes an input to input unit 22 of second display device 120 (S14). For example, as illustrated in (b) and (c) of FIG. 7, the user makes a selection on a tiled image (defect detection image) displayed on first display screen 11 with use of an operation body, for an input to input unit 22. Control device 30 changes the color of the images of the tiles corresponding to the area information input to input unit 22, for display on first display screen 11 and second display screen 21. This allows the user to input area information while viewing the defect detection images displayed on both first display screen 11 and second display screen 21. Therefore, the user is able to input the normal range or the defective range with high accuracy.

Next, the user checks the normal area or the defective area displayed on second display screen 21 (S15).

Next, control device 30 causes the user to confirm whether the normal area or the defective area has been correctly input (S16). In this case, control device 30 may display, on second display screen 21, a selection image for confirming whether the normal area or the defective area has been correctly input.

When the normal area or the defective area has not been correctly input (NO in S16), for example, when the user selects a selection image of No indicating that an input has not been correctly made on first display screen 11, the processing returns to step S13, and a defect detection image is rendered. This allows the user to input the normal area or the defective area (area information) again to input unit 22.

On the other hand, when the user has correctly input the normal area or the defective area (YES in S16), for example, when the user selects a selection image of YES indicating that an input has been correctly made on first display screen 11, defective range identification processor 31 outputs the identified defective area to controller 33 (S17). Defective range identification processor 31 then ends the processing operation in the flowchart in FIG. 4.

In such a manner, even when first display device 110 does not include an input unit such as a touch sensor, control device 30 is capable of identifying the defective area on first display screen 11 with use of second display device 120 that includes input unit 22. Therefore, display system 1a is capable of displaying an image in the normal area excluding the identified defective area.

Next, operational effects of control device 30, a control method, and a program according to Variation 1 will be described.

As described above, in control device 30 according to Variation 1, a normal area in which an image can be displayed normally or a defective area in which an image cannot be displayed normally is input to second display device 120 that includes second display screen 21 that is different from first display screen 11. The obtainer obtains area information that includes the normal area or the defective area from second display device 120.

This allows control device 30 to obtain the area information that includes the normal area or the area information that includes the defective area. Therefore, when obtaining the area information that includes the normal area, control device 30 is capable of identifying, as the defective area, the area of the display area excluding the normal area. Moreover, when obtaining the area information that includes the defective area, control device 30 is capable of identifying the defective area in the display area.

Even when first display device 110 does not include an input unit, or when the input unit is defective, the defective area in the display area of first display device 110 can be identified with use of another second display device 120 mounted in vehicle 2, for example.

Moreover, in control device 30 according to Variation 1, the processor outputs, to second display screen 21, a defect detection image for inputting the normal area or the defective area. The obtainer then obtains the area information that includes the normal area or the defective area input.

With this, a defect detection image is displayed on second display screen 21. Therefore, the user is able to directly input the normal area corresponding to the normal range or the defective area corresponding to the defective range in the defect detection image on second display screen 21 via second display device 120. This allows control device 30 to obtain area information that includes the normal area or the defective area. As a result, it is possible to identify the defective area on first display screen 11.

### Variation 2 of Embodiment

Variation 2 differs from the embodiment in that second display device 120a that includes image capturer 23 is used. Unless otherwise specified, the other structural elements in Variation 2 are similar to those in the embodiment. The similar structural elements are marked with the same reference numerals, and will not be described in detail.

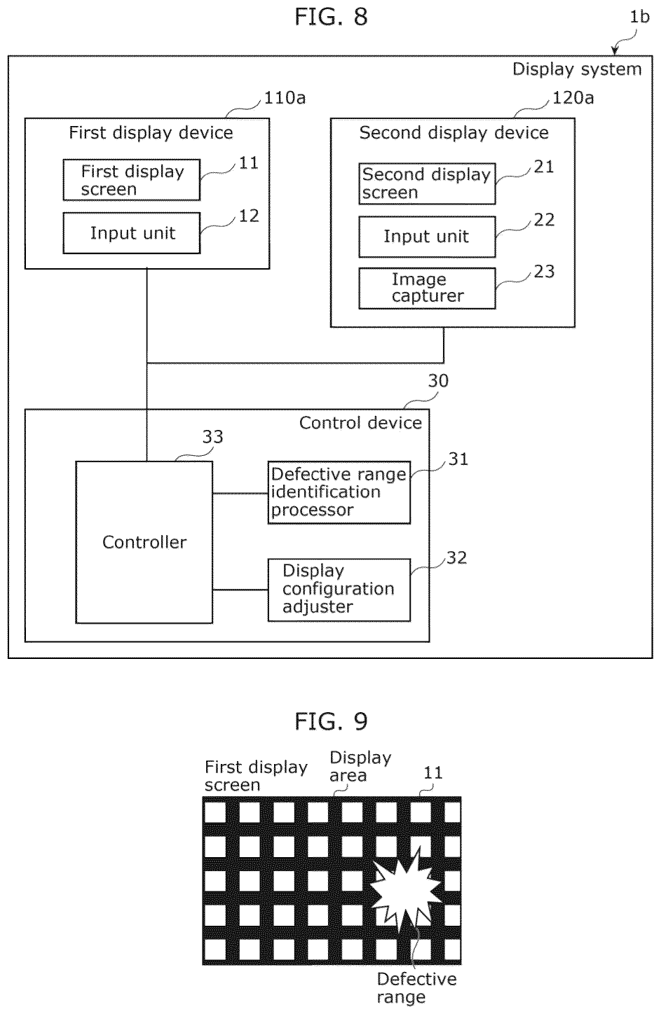

First, display system 1b according to Variation 2 will be described with reference to FIG. 8 and FIG. 9.

FIG. 8 is a block diagram illustrating display system 1b according to Variation 2 of the embodiment. FIG. 9 schematically illustrates a case in which a defect detection image is displayed on first display screen 11 in display system 1b according to Variation 2 of the embodiment.

In addition to first display device 110a and control device 30, display system 1b according to Variation 2 includes second display device 120a. First display device 110a according to Variation 2 includes first display screen 11 and input unit 12 such as a touch sensor, but does not have to include input unit 12.

In display system 1b according to Variation 2, first display screen 11 of first display device 110a may be cracked and defective. In this case, if the user operates first display screen 11 with a finger or the like, the user may be injured. Therefore, Variation 2 assumes a case where an image of the display area of first display screen 11 is captured with use of second display device 120a.

Second display device 120a is, for example, a portable terminal such as a smartphone, a camera sensor, or a PC that includes a camera. In addition to second display screen 21 and input unit 22, second display device 120a includes image capturer 23 that includes an imaging function.

Image capturer 23 captures an image of the display area of first display screen 11 by the user operating second display device 120a. Image capturer 23 is capable of obtaining area information, which is an image that includes a normal area and a defective area, by capturing an image of the display area of first display screen 11. Image capturer 23 outputs the obtained area information to control device 30.

Defective range identification processor 31 of control device 30 obtains the area information, and also obtains, from controller 33, an image on which rendering processing has been performed (expected value of the image displayed on first display screen 11) input to first display screen 11 of first display device 110a. By comparing the area information with the image on which the rendering processing has been performed, defective area identification processor 31 is capable of identifying the defective area included in the display area.

To facilitate identification of the defective area, as illustrated in FIG. 9, a defect detection image may be displayed on the display area of first display screen 11 when image capturer 23 captures an image. Although FIG. 9 illustrates an example of a grid-like defect detection image, the defect detection image may be, for example, a circular or polygonal tiled image, a diagonally shaded image, a wavy shaded image, or a dotted image. The defect detection image is not limited to such examples, and may also be in other known forms. By causing image capturer 23 to capture an image of the display area of first display screen 11 in which the defect detection image is displayed, defective range identification processor 31 may be capable of identifying the defective area included in the display area based on the image (area information) captured by image capturer 23.

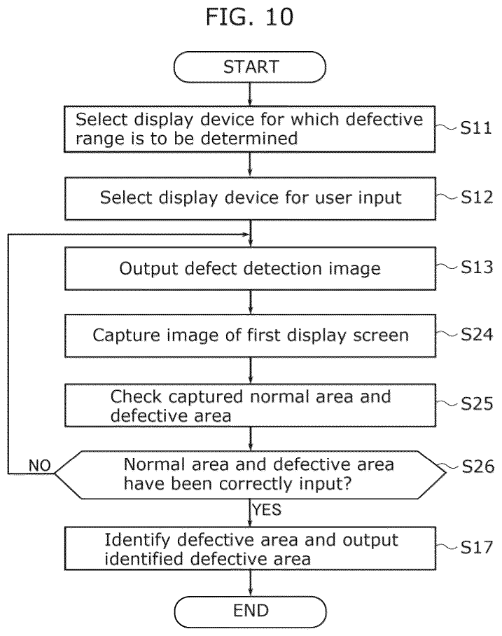

Next, an operation example of control device 30, a control method and a program according to Variation 2 will be described with reference to FIG. 10 and the like. FIG. 10 is a flowchart illustrating an operation example of display system 1b according to Variation 2 of the embodiment.

This operation example assumes a case where one first display screen 11 is partially defective. Therefore, for the same operations as those in FIG. 4 according to the embodiment, the same steps are used, and the descriptions thereof are omitted as appropriate.

First, a display device for which a defective range is to be determined is selected (S11). This operation example assumes a case where first display device 110a is partially defective. Therefore, the user performs an operating on second display screen 21 of second display device 120a to select first display device 110a as a display device for which a defective range is to be determined.

Next, the user selects a display device for input (S12). In this operation example, second display device 120a is selected as the display device for user input.

Next, control device 30 outputs a defect detection image on first display screen 11 as illustrated in FIG. 9 (S13). Step S13 may be omitted when control device 30 is capable of recognizing the defective area by an image.

Next, the user captures an image of the display area of first display screen 11 with use of second display device 120a (S24). This allows second display device 120a to obtain an image (area information) that includes a normal area and a defective area.

Second display device 120a then displays the captured image on second display screen 21. With this, the user checks the image that includes the normal area corresponding to the normal range and the defective area corresponding to the defective range that have been captured (S25).

Next, control device 30 causes the user to confirm whether the normal area and the defective area have been correctly input (recognized) (S26). In other words, control device 30 causes the user to confirm whether the normal area and the defective area determined from the captured image are set as the intended ranges. For example, control device 30 displays, on first display screen 11, the range determined to be the defective range from the captured image in red and the range determined to be the normal range from the captured image in blue. This allows the user to confirm whether the normal area and the defective area have been correctly recognized. In this case, a selection image for allowing the user to confirm whether the normal area and the defective area are set as the intended ranges may be displayed on second display screen 21.

When the user determines that the normal area and the defective area have not been set as the intended ranges (NO in S26), for example, when the user selects a selection image of NO indicating that the display area of first display screen 11 has not been set in accordance with the intended ranges, the processing returns to step S13, and a defect detection image is rendered. This allows the user to capture an image of the display area of first display screen 11 again with use of second display device 120a.

On the other hand, when the user determines that the display area of first display screen 11 that includes the normal area or the defective area has been set in accordance with the intended range (YES in S26), for example, when the user selects a selected image of YES indicating that the display area of first display screen 11 has been set in accordance with the intended range, defective range identification processor 31 outputs the identified defective range to controller 33 (S17). Defective range identification processor 31 then ends the processing operation in the flowchart in FIG. 10.

In such a manner, even without the normal area and the defective area being directly input, control device 30 is capable of identifying the defective area of first display screen 11 by obtaining the captured image of the display area of first display screen 11. Therefore, display system 1b is capable of displaying an image in the normal area excluding the identified defective area.

Next, operational effects of control device 30, a control method, and a program according to Variation 2 will be described.

As described above, in control device 30 according to Variation 2, second display device 120a, which includes second display screen 21 that is different from first display screen 11, captures an image of the display area of first display screen 11. By doing so, second display device 120a obtains, as area information, an image that includes a normal area in which an image can be displayed normally and a defective area in which an image cannot be displayed normally. The obtainer then obtains the image that includes the normal area and the defective area from second display device 120a as area information.

This allows control device 30 to obtain the area information that includes the normal area and the defective area. Therefore, when control device 30 obtains the area information, it is possible to easily identify the normal area and the defective area from the display area.

Even when first display screen 11 of first display device 110a is cracked and defective, the defective area in the display area of first display device 110a can be identified, for example, with use of second display device 120a owned by the user.

Moreover, in control device 30 according to Variation 2, second display device 120a includes image capturer 23. The area information is an image of the display area of first display screen 11 captured by image capturer 23 of second display device 120a.

With this, control device 30 is capable of obtaining area information simply by the user capturing an image of the display area of first display screen 11 with use of image capturer 23 of second display device 120a. Therefore, the defective area can be easily identified without separately including, in first display device 110a or the like, a component for detecting the defective area.

Moreover, in control device 30 according to Variation 2, the processor outputs, to first display screen 11, a defect detection image for inputting a normal area and a defective area. The obtainer obtains an image that includes a normal area and a defective area as area information by capturing of an image of the display area of first display screen 11 in which the defect detection image is displayed.

With this, the defect detection image as illustrated in FIG. 9 is displayed on first display screen 11. Hence, the user is able to input, to control device 30, area information that includes a normal area and a defective area on first display screen 11 by simply capturing an image of the display area of first display screen 11 with use of second display device 120a. With this, control device 30 is capable of obtaining area information, thus facilitating identification of the defective area on first display screen 11.

### Other Variations

Although the control device, the control method, and the program according to the present disclosure have been described based on the embodiment, the present disclosure is not limited to embodiment. Various modifications to the embodiment that can be conceived by those skilled in the art without departing from the teachings of the present disclosure are also included in the scope of the present disclosure.

For example, the controller and the like included in the control device according to the above embodiment is typically implemented as a LSI (large scale integration) that is an integrated circuit. These may be individually configured as single chips or may be configured so that part or all are included in a single chip.

Moreover, the method of circuit integration is not limited to LSIs, and implementation through a dedicated circuit or a general-purpose processor is also possible. A field programmable gate array (FPGA) that can be programmed after the LSI is manufactured, or a reconfigurable processor that can reconfigure the connection and settings of the circuit cells inside the LSI may be used.

Note that, in the above embodiment, each structural element may be configured by dedicated hardware or may be realized by executing a software program suitable for each structural element. Each structural element may be realized by a program execution unit, such as a CPU or a processor, reading and executing a software program recorded on a recording medium, such as a hard disk or a semiconductor memory.

Moreover, all numerical figures used in the forgoing description are merely examples for describing the present disclosure in specific terms, and thus the embodiment in the present disclosure is not limited to the illustrated numerical figures.

Furthermore, the separation of the function blocks in the block diagrams is merely an example, and plural function blocks may be implemented as a single function block, a single function block may be separated into plural function blocks, or part of functions of a function block may be transferred to another function block. Furthermore, the functions of function blocks having similar functions may be processed, in parallel or in a time division manner, by a single hardware or software.

Furthermore, the sequence in which the above-described steps included in the flowcharts are executed is given as an example to describe the present disclosure in specific terms, and thus other sequences are possible. Part of the above-described steps may be executed simultaneously (in parallel) with another step.

While an embodiment has been described herein above, it is to be appreciated that various changes in form and detail may be made without departing from the spirit and scope of the present disclosure as presently or hereafter claimed.

### Further Information about Technical Background to this Application

The disclosures of the following patent applications including specification, drawings, and claims are incorporated herein by reference in their entirety: Japanese Patent Application No. 2022-115428 filed on Jul. 20, 2022, and PCT International Application No. PCT/JP2023/025121 filed on Jul. 6, 2023.

### INDUSTRIAL APPLICABILITY

The present disclosure can be used, for example, for vehicles with a plurality of display devices mounted, and devices and systems other than the vehicles.

1. A control device comprising:
an obtainer that obtains area information that is related to a display area of a first display screen in which an image is displayed; and
a processor that identifies a defective area that is included in the display area, based on the area information obtained, and outputs the defective area identified.

2. The control device according to claim 1,
wherein a normal area in which an image can be displayed normally or a defective area in which an image cannot be displayed normally is input to a first display device that includes the first display screen, and
the obtainer obtains the area information that includes the normal area or the defective area from the first display device.

3. The control device according to claim 2,
wherein the processor outputs, to the first display screen, a defect detection image for inputting the normal area or the defective area, and
the obtainer obtains the area information that includes the normal area or the defective area input.

4. The control device according to claim 1,
wherein a second display device that includes a second display screen that is different from the first display screen obtains, as the area information, a captured image that includes a normal area and a defective area by capturing an image of the display area of the first display screen, the normal area being an area in which an image can be displayed normally, the defective area being an area in which an image cannot be displayed normally, and
the obtainer obtains, as the area information, the captured image that includes the normal area and the defective area from the second display device.

5. The control device according to claim 4,
wherein the second display device includes an image capturer, and
the area information is an image of the display area of the first display screen captured by the image capturer of the second display device.

6. The control device according to claim 4,
wherein the processor outputs, to the first display screen, a defect detection image for inputting the normal area and the defective area, and
the obtainer obtains, as the area information, a captured image that includes the normal area and the defective area by capturing an image of the display area of the first display screen in which the defect detection image is displayed.

7. The control device according to claim 1,
wherein a normal area in which an image can be displayed normally or a defective area in which an image cannot be displayed normally is input to a second display device that includes a second display screen that is different from the first display screen, and the obtainer obtains the area information that includes the normal area or the defective area from the second display device.

8. The control device according to claim 7,
wherein the processor outputs, to the second display screen, a defect detection image for inputting the normal area or the defective area, and
the obtainer obtains the area information that includes the normal area or the defective area input.

9. A control method comprising:
obtaining area information that is related to a display area of a first display screen in which an image is displayed; and
identifying a defective area that is included in the display area based on the area information obtained, and outputting the defective area identified.

10. A non-transitory computer-readable recording medium having recorded thereon a program for causing a computer to execute the control method according to claim 9.
